(19) United States
(12) Patent Application Publication
(10) Pub. No.: US 2018/0252967 A1
(43) Pub. Date: Sep. 6, 2018

(54) QUANTUM DOT LIQUID CRYSTAL BACKLIGHT SOURCE

(71) Applicant: GUANGDONG POLY OPTOELECTRONICS TECH. CO., LTD., Jiangmen City, Guangdong Province (CN)

(72) Inventors: Yang LI, Jiangmen City, Guangdong Province (CN); Yimin ZHU, Jiangmen City, Guangdong Province (CN); Genrong SHAO, Jiangmen City, Guangdong Province (CN)

(73) Assignee: GUANGDONG POLY OPTOELECTRONICS TECH. CO., LTD., Jiangmen City, Guangdong Province (CN)

(21) Appl. No.: 15/757,298

(22) PCT Filed: Aug. 28, 2016
(86) PCT No.: PCT/CN2016/097078

§ 371 Date: Mar. 2, 2018

(30) Foreign Application Priority Data
Jul. 25, 2016 (CN) 201610589470.5

(51) Int. Cl. G02F 1/1335; G02F 1/017; F21V 8/00

(52) U.S. Cl. CPC G02F 1/133603; G02F 1/017; G02F 2001/01791; G02B 6/0025; G02B 6/0031; G02F 1/133608

(57) ABSTRACT

The present invention relates to a quantum dot liquid crystal backlight source, including a blue light LED strip, a fluorescent film containing green quantum dots and a light guide plate, wherein the fluorescent film and the light guide plate are disposed in layers; the blue light LED strip is arranged at one or more lateral sides of the light guide plate; and one surface of the blue light LED strip facing the light guide plate is packaged with a red fluorescent layer. Liquid crystal backlight source of the present invention can avoid that the green light emitted by the green quantum dots is absorbed by red quantum dots or other red fluorescent material, and the blue light LED surface is directly packaged with the red fluorescent layer, so that green light loss can be avoided, the overall brightness of the white light source is increased by 5-10%.

### FIELD OF TECHNOLOGY

The present invention relates to the field of display devices, and in particular relates to a quantum dot liquid crystal backlight source using quantum dot high-color-gamut optical film technology.

### BACKGROUND

At present, quantum dot technology applied to the field of liquid crystal display can substantially improve the color gamut and color vividness of a display device and reduce energy consumption, wherein the color gamut can be increased from 70% (NTSC standard) for the existing mainstream display devices to 100% (NTSC standard), and it can even meet higher color gamut standards, such as Rec.2020 standard. When quantum dot technology is applied to liquid crystal display devices, especially large-size display devices, it generally uses a fluorescent film containing quantum dots (i.e. quantum dot high-color-gamut optical film containing both red light emitting quantum dots and green light emitting quantum dots, which are referred to as red quantum dots and green quantum dots respectively; same below), and a blue light LED backlight for used therewith.

However, there are great drawbacks in the use of the fluorescent film containing both red quantum dots and green quantum dots. Refer to FIG. 1, which is an assembly structure diagram of a liquid crystal backlight source in the prior art. The liquid crystal backlight source 10 includes a frame 11, a blue light LED strip 12, a brightness enhancement film 13, a diffuser film 14, a fluorescent film 15 containing both red and green quantum dots, a light guide plate 16 and a reflective film 17. The brightness enhancement film 13, the diffuser film 14, the fluorescent film 15, the light guide plate 16 and the reflective film 17 are disposed in layers successively from top to bottom and arranged in the frame 11, and the blue light LED strip 12 is arranged at a lateral side of the light guide plate 16. The red quantum dots can absorb green light emitted by the green quantum dots, and then emit red fluorescent light by themselves. This process results in lowered intensity of the green light, and affects the overall brightness and light effect of the backlight. If the intensity of the green light is increased by means of increasing the quantity of the green quantum dots, the red light also become stronger; and if the quantity of the red quantum dots is increased, the intensity of the green light can be lowered due to absorption by the red quantum dots, which also makes it difficult to adjust white spots of the backlight.

In addition, quantum dots prepared in the prior art are mostly II-VI or III-V quantum dots, which are mainly CdSe quantum dots. Such CdSe quantum dots, however, contain some relatively dangerous components, with higher requirement on the environment; moreover, such quantum dots are prepared by a complex process under strict conditions free of water and oxygen, with high requirement on equipment and high production cost, and thus can hardly be manufactured on a large scale. Therefore, finding other types of fluorescent material to replace part of II-VI and III-V quantum dots while ensuring wide color gamut of backlight is key to whether quantum dot fluorescent material can be widely and extensively used.

### SUMMARY

An object of the present invention is to overcome the shortcomings and disadvantages of the prior art and provide a quantum dot liquid crystal backlight source.

The present invention is achieved by the following technical solution: a quantum dot liquid crystal backlight source, including a blue light LED strip, a fluorescent film containing green quantum dots and a light guide plate, wherein the fluorescent film and the light guide plate are disposed in layers; the blue light LED strip is arranged at one or more lateral sides of the light guide plate; and one surface of the blue light LED strip facing the light guide plate is packaged with a red fluorescent layer.

As compared with the prior art, only green quantum dots are added to the fluorescent film of the quantum dot liquid crystal backlight source of the present invention, to avoid that the green light emitted by the green quantum dots is absorbed by red quantum dots or other red fluorescent material, and the blue light LED surface is directly packaged with the red fluorescent layer, so that green light loss can be avoided, the overall brightness of the white light source is increased by 5-10%; or the quantity of green quantum dots is reduced at the same color gamut value and brightness, thereby reducing the quantity of quantum dots in the whole system.

Further, the red fluorescent layer is prepared by dissolving a red fluorescent material into an adhesive, then adding a solvent to obtain a glue containing the red fluorescent material, coating the glue on the surface of the blue LED strip, and solidifying the glue to form the red fluorescent layer.

Further, the red fluorescent material is one or more of II-VI and III-V quantum dots, perovskite quantum dots, a fluorosilicate phosphor, a fluorotitanate phosphor or a nitrogen oxide phosphor.

Further, the red fluorescent material has an emission wavelength of 610 nm-650 nm.

Further, the red fluorescent material in the glue has a mass concentration of 5%-60%.

Further, the II-VI and III-V quantum dots are CdSe quantum dots.

Further, the perovskite quantum dots has a structure formula of APbX₃, wherein A=Cs or CH₃NH₃; and X=Cl, Br or I. The perovskite quantum dots are high in quantum efficiency of fluorescence, narrow in emission peak width of half height, and free of CdSe component. The preparation process thereof is simple, so that large-scale production is easy to achieve, and with a low production cost, the perovskite quantum dots are an ideal material for replacing II-VI and III-V quantum dots.

Further, the fluorosilicate phosphor is one or more of K₂SiF₆:Mn⁴⁺, Na₂SiF₆:Mn⁴⁺, Na₂SiF₆:Nd³⁺,Yb³⁺ or Ca₂₋₂ₓEu(II)₂ₓMg₅(Si₄O₁₁)₂F₂; and the fluorotitanate phosphor is K₂TiF₆:Mn⁴⁺.

Further, the adhesive is one or more of photocurable resin, thermosetting resin, thermoplastic resin, organic silicone resin, polyurethane, acrylic resin, epoxy resin, ethylene-vinyl acetate copolymer, polyolefin and polycarbonate; and the solvent is one or more of aromatic hydrocarbons, esters, ethers, alkanes and halogenated hydrocarbons.

Further, the quantum dot liquid crystal backlight source further includes a frame, a brightness enhancement film, a diffuser film and a reflective film; and the brightness enhancement film, the diffuser film, the fluorescent film, the light guide plate and the reflective film are disposed in layers successively from top to bottom and arranged in the frame.

The present invention is described in detail below in conjunction with the drawings for better understanding and implementation.

### BRIEF DESCRIPTION OF THE DRAWINGS

FIG. 1 is an assembly structure diagram of a liquid crystal backlight source in the prior art;

FIG. 2 is an assembly structure diagram of a quantum dot liquid crystal backlight source of the present invention;

FIG. 3 is a spectrum diagram of a quantum dot liquid crystal backlight source in embodiment 1 of the present invention;

FIG. 4 is a spectrum diagram of a quantum dot liquid crystal backlight source in embodiment 2 of the present invention;

FIG. 5 is a spectrum diagram of a quantum dot liquid crystal backlight source in embodiment 3 of the present invention;

FIG. 6 is a spectrum diagram of a quantum dot liquid crystal backlight source in embodiment 4 of the present invention;

FIG. 7 is a spectrum diagram of a liquid crystal backlight source in the prior art.

### DETAILED DESCRIPTION

### Embodiment 1

Specific embodiments of the present invention will be further described in detail in conjunction with the drawings and embodiments.

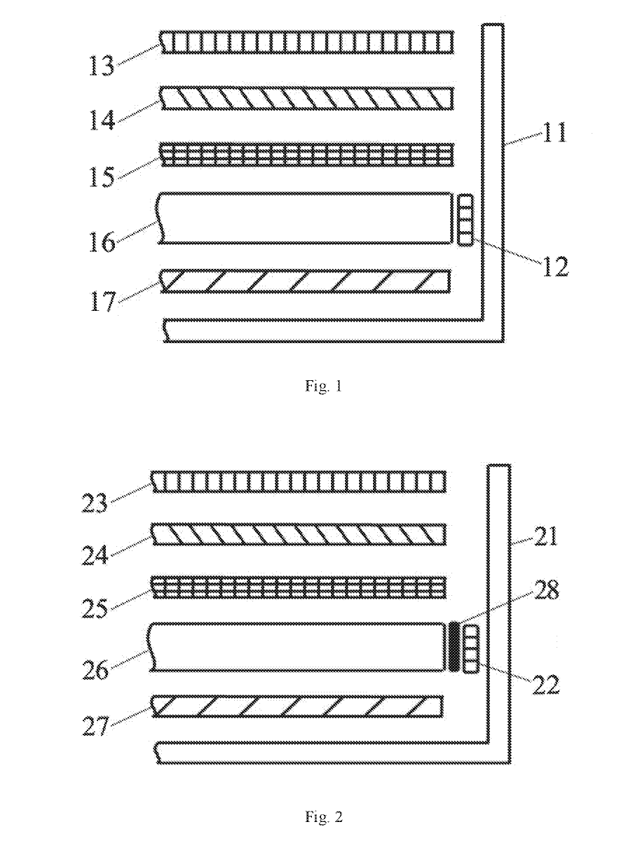

The present invention provides a quantum dot liquid crystal backlight source. Referring to FIG. 2, which is an assembly structure diagram of the quantum dot liquid crystal backlight source of the present invention, the quantum dot liquid crystal backlight source 20 includes a frame 21, a blue light LED strip 22, a brightness enhancement film 23, a diffuser film 24, a fluorescent film 25 containing green quantum dots, a light guide plate 26 and a reflective film 27. The brightness enhancement film 23, the diffuser film 24, the fluorescent film 25 containing green quantum dots, the light guide plate 26 and the reflective film 27 are disposed in layers successively from top to bottom and arranged in the frame 11. The blue light LED strip 22 is arranged at a lateral side of the light guide plate 16. The surface of the blue light LED strip 22 facing the light guide plate 26 is packaged with a red fluorescent layer 28. The red fluorescent layer 28 is prepared in such a manner that a red fluorescent material is mixed with an adhesive to form glue, which is then coated on a blue light LED surface, to form the red fluorescent layer 28 after solidification.

In this embodiment, the green fluorescent material in the fluorescent film 25 is one or more of green light emitting II-VI and III-V quantum dots and perovskite quantum dots, wherein the emission wavelength of the green quantum dots is 510 nm-540 nm, preferably 530 nm.

The red fluorescent material of the red fluorescent layer 28 in this embodiment is II-VI and III-V red quantum dots with an emission wavelength of 610 nm-650 nm, preferably 630 nm. A preparation method of the red fluorescent layer 28 includes the following steps: dissolving the II-VI and III-V red quantum dots with the emission wavelength of 630 nm into a certain amount of adhesive, and adding a certain amount of solvent to obtain glue containing the red quantum dots, the mass concentration of the red quantum dots in the glue being 5%; and coating the glue on the surface of the blue LED strip, and solidifying the glue by thermosetting or UV curing to form the red fluorescent layer. The surface of the blue light LED strip is packaged with the red fluorescent quantum dots by using the above method. In this embodiment, the adhesive is one or more of photocurable resin, thermosetting resin, thermoplastic resin, organic silicone resin, polyurethane, acrylic resin, epoxy resin, ethylene-vinyl acetate copolymer, polyolefin and polycarbonate. The solvent is one or more of aromatic hydrocarbons, esters, ethers, alkanes and halogenated hydrocarbons.

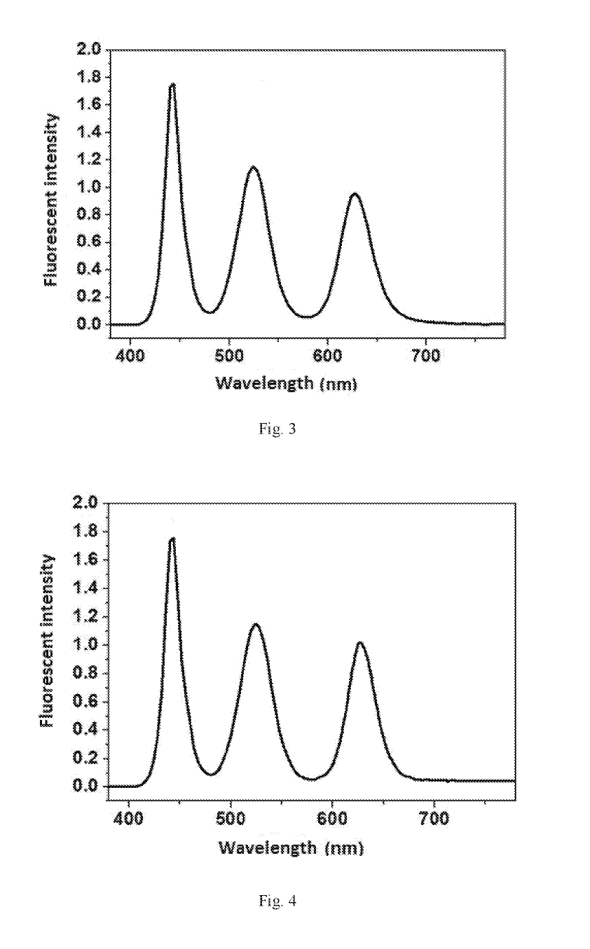

In this embodiment, the II-VI and III-V red quantum dots with the emission wavelength of 630 nm are preferably CdSe red quantum dots. Refer to FIG. 3, which is a spectrum diagram of the quantum dot liquid crystal backlight source in this embodiment. The brightness of the quantum dot liquid crystal backlight source formed by packaging the surface of the blue light LED strip with the red CdSe quantum dots reaches 5325 cd/m², and the color gamut of the backlight source reaches 110% NTSC.

During use of the quantum dot liquid crystal backlight source, the blue light LED strip is used as a primary light source of the backlight, and the red fluorescent layer packaging the surface of the blue light LED strip absorbs part of blue light emitted by the blue light LED strip and then emits red fluorescent light. The unabsorbed blue light and the red fluorescent light together form mixed light. After being uniformed by the light guide plate, the mixed light is vertically radiated on the fluorescent film containing green quantum dots covering the front side of light guide plate. The fluorescent film absorbs part of the blue light, and then emits green fluorescent light. Finally, the unabsorbed blue light, red light and green light together form a white light source serving as a light source of the liquid crystal backlight source.

As compared with the prior art, only green quantum dots are added to the fluorescent film of the quantum dot liquid crystal backlight source of the present invention, to avoid that the green light emitted by the green quantum dots is absorbed by red quantum dots or other red fluorescent material, thus avoiding green light loss, and increasing the overall brightness of the white light source by 5-10%; or reducing the quantity of green quantum dots at the same color gamut value and brightness, thereby reducing the quantity of quantum dots in the whole system. Compared with a process of adding both red quantum dots and green quantum dots to a traditional quantum dot fluorescent film, it has the advantage of facilitating adjustment of relative intensity of red, green and blue light. If a traditional green fluorescent film is used, as red quantum dots or other red fluorescent material absorbs green light and emits red light, when the concentration of green quantum dots in the fluorescent film is increased, the intensity of green fluorescent light is increased, and the intensity of red fluorescent light is also increased; and when the concentration of red quantum dots in the fluorescent film is increased, the intensity of red fluorescent light is increased, and the intensity of green fluorescent light is reduced instead. In the case of the quantum dot liquid crystal backlight source of the present invention, when the concentration of green quantum dots in the fluorescent film is changed, the intensity of red fluorescent light is not changed, which is favorable for adjustment of white light of the backlight.

### Embodiment 2

This embodiment is structurally substantially same as the quantum dot liquid crystal backlight source described in embodiment 1, and only differs in the red fluorescent layer 28. The red fluorescent material of the red fluorescent layer 28 in this embodiment is red perovskite quantum dots. A preparation method of the red fluorescent layer 28 includes the following steps: dissolving the red perovskite quantum dots into a certain amount of adhesive, and adding a certain amount of solvent to obtain glue containing the red quantum dots, the mass concentration of the red quantum dots in the glue being 15%; and coating the glue on the surface of the blue LED strip, and solidifying the glue by thermosetting or UV curing to form the red fluorescent layer.

In this embodiment, the structure formula of the red perovskite quantum dots is APbX₃, wherein A=Cs or CH₃NH₃; and X=Cl, Br or I. The red perovskite quantum dots is preferably CsPbI₃ quantum dots, a preparation method of which is as follows: adding a certain amount of CsCO₃ and a ligand in a molar ratio to a specific organic solvent, heating to a temperature within the range of 100−200° C., and then injecting a PbI₂ containing solution for reaction for 1-30 min to obtain the CsPbI₃ quantum dots.

Refer to FIG. 4, which is a spectrum diagram of the quantum dot liquid crystal backlight source in this embodiment. The brightness of the quantum dot liquid crystal backlight source formed by packaging the surface of the blue light LED strip with the red CsPbI₃ quantum dots reaches 4640 cd/m², and the color gamut of the backlight source reaches 99% NTSC.

### Embodiment 3

This embodiment is structurally substantially same as the quantum dot liquid crystal backlight source described in embodiment 1, and only differs in the red fluorescent layer 28. The red fluorescent material of the red fluorescent layer 28 in this embodiment is a red fluorosilicate or fluorotitanate phosphor. A preparation method of the red fluorescent layer 28 includes the following steps: dissolving the red fluorosilicate phosphor into a certain amount of adhesive, and adding a certain amount of solvent to obtain glue containing the red phosphor, the mass concentration of the red phosphor in the glue being 40%; and coating the glue on the surface of the blue LED strip, and solidifying the glue by thermosetting or UV curing to form the red fluorescent layer.

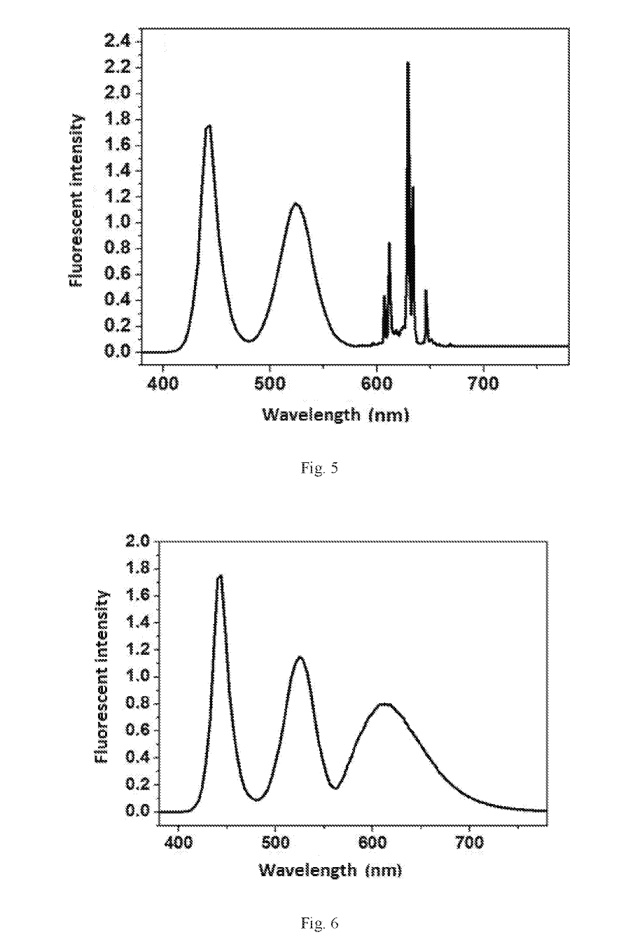

In this embodiment, the red fluorosilicate phosphor is preferably K₂SiF₆:Mn⁴⁺ but not limited thereto, and may also be Na₂SiF₆:Mn⁴⁺, Na₂SiF₆:Nd³⁺,Yb³⁺, Ca₂₋₂ₓ(Eu(II)₂ₓ(Mg₅(Si₄O₁₁)₂F₂. The red fluorotitanate phosphor is K₂TiF₆:Mn⁴⁺ but not limited thereto. Refer to FIG. 5, which is a spectrum diagram of the quantum dot liquid crystal backlight source in this embodiment. The brightness of the quantum dot liquid crystal backlight source formed by packaging the surface of the blue light LED strip with K₂SiF₆:Mn⁴⁺ reaches 5128 cd/m², and the color gamut of the backlight source reaches 97% NTSC.

### Embodiment 4

This embodiment is structurally substantially same as the quantum dot liquid crystal backlight source described in embodiment 1, and only differs in the red fluorescent layer 28. The red fluorescent material of the red fluorescent layer 28 in this embodiment is a red nitrogen oxide phosphor. A preparation method of the red fluorescent layer 28 includes the following steps: dissolving the red nitrogen oxide phosphor into a certain amount of adhesive, and adding a certain amount of solvent to obtain glue containing the red phosphor, the mass concentration of the red phosphor in the glue being 60%; and coating the glue on the surface of the blue LED strip, and solidifying the glue by thermosetting or UV curing to form the red fluorescent layer.

In this embodiment, the red nitrogen oxide phosphor is preferably CaAlSiN₃:Eu²⁺ but not limited thereto, and may also be M₂ₓSi₅N₈:Euₓ²⁺ (M=Ca, Sr or Ba, wherein 0≤x≤0.4). Refer to FIG. 6, which is a spectrum diagram of quantum dot liquid crystal backlight source in this embodiment. The brightness of the quantum dot liquid crystal backlight source formed by packaging the surface of the blue light LED strip with CaAlSiN₃:Eu²⁺ reaches 5004 cd/m², and the color gamut of the backlight source reaches 96% NTSC.

### Comparative Embodiment

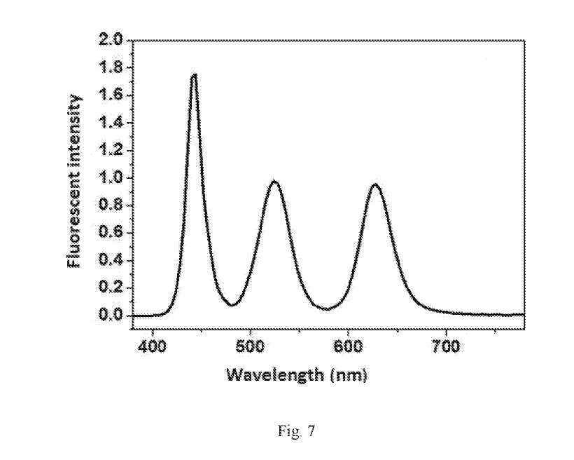

This embodiment is a liquid crystal backlight source in the prior art, structurally as shown in FIG. 1. The liquid crystal backlight source includes a frame 11, a blue light LED strip 12, a brightness enhancement film 13, a diffuser film 14, a fluorescent film 15 containing both red and green quantum dots, a light guide plate 16 and a reflective film 17. The brightness enhancement film 13, the diffuser film 14, the fluorescent film 15, the light guide plate 16 and the reflective film 17 are disposed in layers successively from top to bottom and arranged in the frame 11, and the blue light LED strip 12 is arranged at a lateral side of the light guide plate 16. In this comparative embodiment, the red quantum dots in the fluorescent film 15 are CdSe quantum dots. Refer to FIG. 7, which is a spectrum diagram of the liquid crystal backlight source in the prior art. In this comparative embodiment, the brightness of the liquid crystal backlight source is 4870 cd/m², and the color gamut of the backlight source is 108% NTSC.

In the quantum dot liquid crystal backlight source of the present invention, as compared with the crystal backlight source of the prior art, only green quantum dots are added to the fluorescent film by using the method of packaging the surface of the blue light LED strip with the red fluorescent material, to avoid that the green light emitted by the green quantum dots is absorbed by red quantum dots or other red fluorescent material, thus avoiding green light loss, and increasing the overall brightness of the white light source by 5-10%; or reducing the quantity of green quantum dots at the same color gamut value and brightness, thereby reducing the quantity of quantum dots in the whole system.

The present invention is not limited the above embodiments. If various modification or variations are made to the present invention without departing from the spirit and scope of the present invention, the present invention is also intended to encompass such modifications and variations as long as they fall into the scope of the claims of the present invention and their equivalent technology.

1. A quantum dot liquid crystal backlight source, characterized by comprising a blue light LED strip, a fluorescent film containing green quantum dots and a light guide plate, wherein the fluorescent film and the light guide plate are disposed in layers; the blue light LED strip is arranged at one or more lateral sides of the light guide plate; and one surface of the blue light LED strip facing the light guide plate is packaged with a red fluorescent layer.

2. The quantum dot liquid crystal backlight source according to claim 1, characterized in that the red fluorescent layer is prepared by dissolving a red fluorescent material into an adhesive, then adding a solvent to obtain a glue containing the red fluorescent material, coating the glue on the surface of the blue LED strip, and solidifying the glue to form the red fluorescent layer.

3. The quantum dot liquid crystal backlight source according to claim 2, characterized in that the red fluorescent material is one or more of II-VI and III-V quantum dots, perovskite quantum dots, a fluorosilicate phosphor, a fluorotitanate phosphor or a nitrogen oxide phosphor.

4. The quantum dot liquid crystal backlight source according to claim 2, characterized in that the red fluorescent material has an emission wavelength of 610 nm-650 nm.

5. The quantum dot liquid crystal backlight source according to claim 2, characterized in that the red fluorescent material in the glue has a mass concentration of 5%-60%.

6. The quantum dot liquid crystal backlight source according to claim 3, characterized in that the II-VI and III-V quantum dots are CdSe quantum dots.

7. The quantum dot liquid crystal backlight source according to claim 3, characterized in that the perovskite quantum dots has a structure formula of APbX₃, wherein A=Cs or CH₃NH₃; and X=Cl, Br or I.

8. The quantum dot liquid crystal backlight source according to claim 3, characterized in that the fluorosilicate phosphor is one or more of K₂SiF₆:Mn⁴⁺, Na₂SiF₆:Mn⁴⁺, Na₂SiF₆:Nd³⁺, Yb³⁺ or Ca₂₋₂ₓEu(II)₂ₓMg₅(Si₄O₁₁)₂F₂; and the fluorotitanate phosphor is K₂TiF₆:Mn⁴⁺.

9. The quantum dot liquid crystal backlight source according to claim 2, characterized in that the adhesive is one or more of photocurable resin, thermosetting resin, thermoplastic resin, organic silicone resin, polyurethane, acrylic resin, epoxy resin, ethylene-vinyl acetate copolymer, polyolefin and polycarbonate; and the solvent is one or more of aromatic hydrocarbons, esters, ethers, alkanes and halogenated hydrocarbons.

10. The quantum dot liquid crystal backlight source according to claim 1, characterized in that the quantum dot liquid crystal backlight further includes a frame, a brightness enhancement film, a diffuser film and a reflective film; and the brightness enhancement film, the diffuser film, the fluorescent film, the light guide plate and the reflective film are disposed in layers successively from top to bottom and arranged in the frame.
